(19) United States
(12) Patent Application Publication
(10) Pub. No.: US 2005/0280808 A1
(43) Pub. Date: Dec. 22, 2005

(54) Method and system for inspecting a wafer

(75) Inventors: Henning Backhauss, Wetzlar (DE); Albert Kreh, Solms (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Semiconductor GmbH, Wetzlar (DE)

(21) Appl. No.: 11/153,646

(22) Filed: Jun. 15, 2005

(30) Foreign Application Priority Data
Jun. 16, 2004 (DE) 10 2004 029 014.8

(51) Int. Cl. G01N 21/88

(52) U.S. Cl. 356/237.2

(57) ABSTRACT

A method for inspecting a wafer includes telecentrically illuminating, with a radiation source, a region of the wafer surface to be inspected. An image of wafer region is acquired using a camera. The wafer region is inspected using the acquired image.

### CROSS REFERENCE TO RELATED APPLICATIONS

Priority is claimed to German patent application 10 2004 029 014.8, the entire disclosure of which is hereby incorporated by reference herein.

### FIELD OF THE INVENTION

The invention concerns a method for inspecting a wafer, in particular for detecting macrodefects such as exposure defects, at least one region to be inspected of the wafer surface being illuminated with a radiation source, an image of that surface region being acquired by means of a camera, and the wafer surface being inspected on the basis of the image obtained; as well as a wafer inspection system having a radiation source for illuminating at least one region to be inspected of the wafer surface, and having a camera for acquiring an image of that surface region.

### BACKGROUND OF THE INVENTION

Inspection of wafers having an exposed resist layer is used for defect detection in semiconductor fabrication. During the process of exposing a wafer coated with resist, structures are exposed onto the resist layer in segments. The exposure parameters, such as exposure time, exposure dose, focus, and position, must be set in very accurate and stable fashion so that only minor deviations, which cannot affect the structure that is to be produced, occur from one exposed segment to another. As a rule, a wafer is inspected for incorrect exposures only after development of the resist. Upon inspection, incorrectly exposed segments exhibit in some cases very small contrast differences as compared with the correctly exposed segments. If illumination and observation are polychromatic, the contrast changes are perceived as color changes.

Incorrect exposures usually cause defective products. A wafer having a defective already-developed resist layer can, however, be reused by way of a rework operation, thus increasing yield. A great demand therefore exists for reliable defect detection in the semiconductor production process.

A method and a system for optical inspection of a wafer surface are known from U.S. Pat. No. 6,292,260 B1. Here several radiation sources are used to illuminate the wafer surface, the surface being irradiated perpendicularly from above in bright-field mode by means of a first radiation source with the aid of a semitransparent deflecting mirror, and two further radiation sources, arranged opposite one another at an angle of 180°, being mounted close to the wafer surface and illuminating that surface in raking fashion at a low angle in dark-field mode in order to detect scratches and particles. The radiation proceeding from the entire wafer surface is detected by means of a CCD camera directed perpendicularly onto the wafer surface, the acquired images being compared, for defect detection, with an optimum reference image (almost defect-free structures).

In this known method with large-aperture illumination of the wafer surface, refracted, scattered, and reflected light deriving from various regions of the wafer surface is averaged over a variety of solid angles. For this reason, the contrast difference between exposed segments on the wafer surface that were exposed with exposure parameters differing from one another is very small, so that defects can be detected only with difficulty.

U.S. Pat. No. 5,777,729 discloses a further method and a further apparatus for wafer inspection, the wafer surface being monochromatically illuminated by means of an elongated, extended planar radiator. Because of the extent of the radiator, the wafer surface is diffusely illuminated at a wide variety of angles. One or more CCD cameras detect the radiation scattered and reflected from the surface. A grid model is taken as the basis for the structure of the wafer surface, higher orders of refracted radiation being detected. Defects in the structure of the wafer surface can be ascertained by comparing the acquired image with an optimum reference image (defect-free structures). Scattered light is additionally acquired in order to detect undesired particles.

This known wafer inspection method is complex, however, because a large illumination source and many detectors are necessary. The large number of detectors moreover necessitates a large calculation outlay upon evaluation of the acquired images for inspection of the wafer surface. Here again, it is found that the contrast information in the acquired images is often, in practice, insufficient for reliable detection of all macrodefects.

A coaxial diffuse polychromatic illumination using a planar fiber illumination system, as well as a lateral polychromatic oblique illumination using a linear fiber illumination system, have also been used for wafer inspection. It has been found that polychromatic illumination alone cannot eliminate the weak contrast caused by the diffuse illumination, and that oblique illumination is quite suitable for the recognition of particles, but of only limited suitability for recognizing exposure defects.

A system marketed by the Applicant, the Leica LDS3000 M, combines a variety of methods for detecting micro- and macrodefects on wafer surfaces. This involves examining individual surfaces on the wafer as well as the entire wafer surface. Typical macrodefects detected are: scratches, hot spots, exposure defects such as unexposed areas or areas of defocused exposure, particles on the surface, and global defects that are present over multiple cells and become visible only by examination of the entire wafer surface. The system uses a combination of bright-field and dark-field illumination. The images obtained are evaluated by means of image processing software, here again a comparison with a defect-free reference image (“golden image”) being utilized. The defects detected are classified with reference to a knowledge database. It has been found that more contrast must be produced for reliable detection of exposure defects with this known system.

### SUMMARY OF THE INVENTION

An object of the present invention is therefore to provide a method and a system for inspecting wafers, in particular for detecting macrodefects such as exposure defects, which make it possible to display defects and faults on the wafer surface with sufficient contrast.

The present invention provides a method for inspecting a wafer. The method includes:
telecentrically illuminating, with a radiation source, at least one region of the wafer surface to be inspected;
acquiring an image of the at least one region using a camera; and
inspecting the at least one region using the acquired image.

In the method according to the present invention, the wafer surface or at least the region to be inspected is illuminated telecentrically. An image of this surface region is acquired by means of a camera, and the image is then inspected for the defects and faults of interest.

The concept of telecentricity is particularly important in non-contact optical measurement technology, and will be explained below. With this measurement technology, the object under examination is imaged by means of object space telecentric objectives. Such objectives have the property of always imaging a subject at the same size regardless of its distance. In automated non-contact measurement, it is generally impossible to measure the test item from exactly the same position every time. This circumstance has led to the development of object space telecentric objectives. An object space telecentric beam path exists when the main beams extend in axially parallel fashion in the object space. If an object of fixed size is imaged sharply with an object space telecentric objective, a defocused object of the same size would be blurry, but would again be imaged at the same size, since its main beam extends telecentrically, i.e. parallel to the optical axis, in the object space. This result can be improved even further by using a double telecentric, i.e. both object space and image space telecentric, objective.

With the telecentric illumination of the wafer surface according to the present invention, the surface is illuminated by ray bundles extending parallel to one another. The result is that every point on the object (wafer surface) is illuminated from the same spatial direction and at the same solid angle. Because the illumination is not diffuse, i.e. not averaged over different spatial directions, an improvement is achieved in the contrast difference between correctly and incorrectly exposed segments on the wafer surface.

It is advantageous to optimize the image contrast further by adjusting the illumination angle. Two parameters are available for this, namely on the one hand the illumination angle with reference to the plane of the wafer surface, and on the other hand the illumination angle with reference to the extension of the structures on the wafer surface. This contrast optimization capability does not exist with conventional large-aperture (diffuse) illumination.

It has been found that an incident illumination, preferably at an angle in a range from 3° to 90°, more preferably from 10° to 85°, more preferably from 15° to 85°, more preferably from 25° to 80°, more preferably of 45°+/−10°, relative to the wafer surface, produces good contrast differences. The exact angle selection is usefully made by maximizing the contrast differences between correctly and incorrectly exposed wafer segments.

It has furthermore been found that large contrast differences can be established if illumination occurs substantially parallel to the extension of a main structure extending on the wafer surface. As a rule, the wafer surface is covered with, in most cases, two parallel main structures extending perpendicular to one another. Large contrast differences are obtained when the projection of the bundle axes of the telecentric illuminating radiation extends onto the wafer surface parallel to one of the aforesaid main structures.

Here again, however, it is generally true that the illumination angle relative to the extension of the main structures on the wafer can be set in such a way that maximum contrast differences between incorrectly and correctly exposed segments are established.

It may be advantageous additionally to illuminate the wafer surface in such a way that an observation in dark-field mode is possible. It is useful for this purpose to direct two irradiation sources onto the wafer surface at a low angle (raking light), the two radiation directions of these radiation sources preferably enclosing between them an angle of 90° and being directed onto the same region to be inspected of the wafer surface. This additional dark-field observation can furnish further valuable information in the acquired image concerning defects and faults such as scratches and particles.

It is advantageous in this context if the projection of the radiation direction of the dark-field irradiation source(s) onto the wafer surface encloses an angle of approximately 45° with a main structure extending on that wafer surface. This orientation has a contrast-enhancing effect on the faults and defects to be detected.

It is further advantageous if the wafer surface is additionally illuminated in bright-field mode. This can occur alternatively or in addition to the aforementioned dark-field illumination. The additional bright-field illumination can furnish further valuable information in the acquired image concerning defects such as color defects or wetting defects.

It is additionally advantageous in the context of the method according to the present invention if the camera for imaging the region to be inspected of the wafer surface is equipped with an (object space and possibly also image space) telecentric objective. As a result, every object point can be imaged by the camera at the same observation angle and the same solid angle. This reduces noise in the camera image. An area camera that images the region to be imaged of the wafer surface can be used.

Alternatively, the camera can be equipped with a non-telecentric object (so-called entocentric objective, for example a normal, macro, or telephoto objective), if the working distance is very much greater than the diagonal of the object field. The beam path can then still be referred to, in practice and for purposes of this Application, as object space telecentric.

The radiation acquired by the camera from the illuminated region of the wafer surface is made up of radiation that has been refracted, scattered, and reflected from the structures of the wafer surface. As a result of the telecentric illumination according to the present invention, a defined, limited inventory of angles is offered to every point in the object field on the wafer surface, so that the characteristics of the illumination differ very little from one segment to another. When a telecentric objective is used, an analogous situation exists for the observation side. With this procedure, homogeneous illumination and observation characteristics can be produced over the region to be examined of the wafer surface, so that incorrectly exposed segments are quickly detectable because of the large contrast difference.

As an alternative to a monochromatic illumination, it is useful to select a polychromatic illumination, since in this case of information from several colors can be employed to detect defects and faults. A polychromatic light source can be used for this, or multiple monochromatic light sources utilized in physically adjacent or also chronologically sequential fashion.

It has furthermore been found that exposure defects can readily be detected if the camera is arranged with its axis substantially parallel to the surface normal line of the wafer surface and directed onto the illuminated region of the wafer surface. Observation is thus best performed perpendicularly from above, while illumination is performed obliquely in incident mode.

Wavelengths from the visible to the ultraviolet region can preferably be used. Wavelengths in this region interact most strongly with the structures to be examined on the wafer surface.

It proves advantageous to use a point-like radiator or a small-area planar radiator, such as an optical waveguide, as the radiation source, a lens system being placed in front to produce telecentric illumination. The use of such small-area radiators results in each case in converging radiation bundles which have a small beam angle, i.e. a small illumination aperture. This small illumination aperture does not prove troublesome for the purposes of the invention, so that the illumination can be said to be sufficiently telecentric within the meaning of the invention,.

The subject matter of the invention is furthermore a wafer inspection system having a radiation source for illuminating at least one region to be inspected of the wafer surface, and a camera for acquiring an image of that surface region. The radiation source is configured, in this context, to produce telecentric illumination.

As already explained in connection with the method according to the present invention, the radiation source can be configured in such a way that a point-like radiator or a small-area planar radiator is provided, a lens system being placed in front of the radiator in order to produce telecentric illumination. A optical waveguide can be used, for example, as the radiator. This concrete embodiment of the radiation source ensures telecentric illumination for purposes of the present invention.

With regard to the embodiments of the wafer inspection system according to the present invention, and the advantages resulting therefrom, reference may be made to the explanations of the invention in connection with the aforesaid method according to the present invention. Further embodiments of the wafer inspection system according to the present invention furthermore result from the exemplifying embodiments explained below.

### BRIEF DESCRIPTION OF THE DRAWINGS

The invention and its advantages will be explained below in more detail with reference to exemplifying embodiments presented in the Figures.

FIG. 1 schematically shows a radiation source having a lens system for producing telecentric illumination, FIG. 1A being a general view and FIG. 1B a detail view;

FIG. 2 schematically shows a system for inspecting wafers, for implementation of a method for inspecting wafers;

FIG. 3 again shows, very schematically, the fundamental construction of the wafer inspection system of FIG. 2, in a side view (FIG. 3A) and a plan view (FIG. 3B);

FIG. 4 shows, once again very schematically, a wafer inspection apparatus according to FIG. 2 having additional illumination sources for observation in bright-field and dark-field modes (FIG. 4A), FIG. 4B being a plan view.

### DETAILED DESCRIPTION OF THE INVENTION

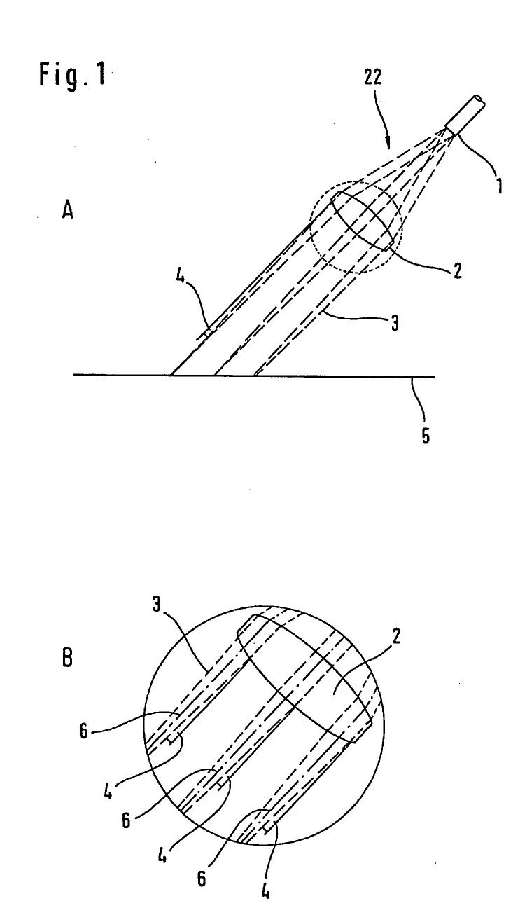

FIG. 1 shows the basic principle of the telecentric illumination, according to the present invention, of an object plane 5 which, in the concrete application, represents a wafer surface. A small-area planar radiator, as represented by an optical waveguide, is used as radiation source 22 in this exemplifying embodiment. Beam bundles 3 extending in parallel fashion and having a small illumination aperture 4 are generated by means of a lens system 2 (collimating optical system), depicted here only schematically. Beam bundles 3 strike object plane 5 in such a way that every point on that object plane is illuminated from the same spatial direction and at the same solid angle.

The region outlined with a dotted circle in FIG. 1A is reproduced in enlarged fashion in FIG. 1B. The beam bundles extending in parallel fashion are once again labeled 3. It is clearly evident from the detail view that axes 6 of beam bundles 3 extend parallel to one another. Illumination aperture 4 in this detail view corresponds to illumination aperture 4 of FIG. 1A. The small illumination aperture 4 ensures that diffuse illumination of object plane 5, or illumination with large apertures, does not occur.

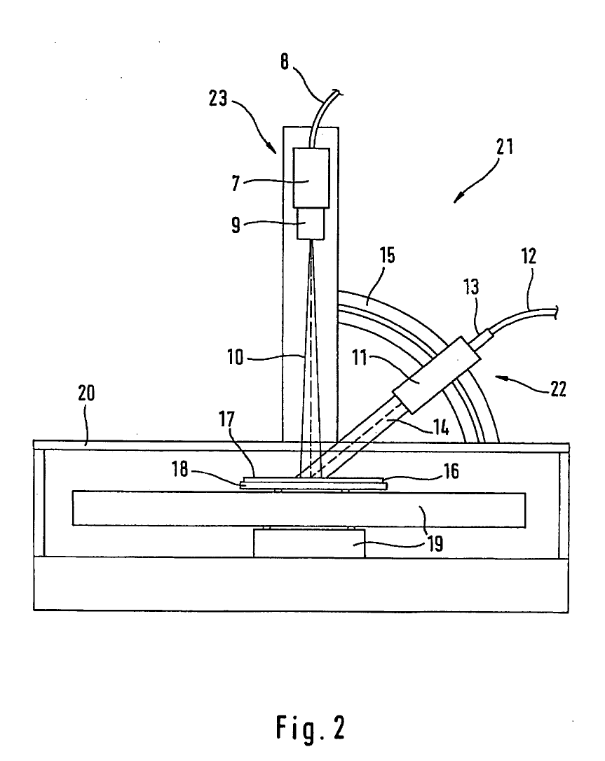

FIG. 2 schematically shows a system 21 for inspecting a wafer 16. During the manufacture of such a wafer, it passes through multiple manufacturing steps during which various layers are applied onto the surface, those layers often being partially removed again so as to constitute an overall structure that implements a certain electrical circuit. In addition to the application of layers, the manufacturing steps include etching, ion implantation, diffusion processes, metallization operations, etc. A photolithography process, in which the wafer surface is uniformly coated with a photoresist, is used to constitute a structured layer. The photoresist layer is exposed using a mask. The exposed photoresist segments experience a change in chemical properties, so that corresponding photoresist segments can be removed from the surface by the subsequent development step. What remains is the desired photoresist structure. A variety of fabrication steps can then follow, in which the surface is subjected to various chemical treatments, ion implantation operations, metal coating operations, etching processes, and the like, without influencing the layers located beneath the photoresist structure. The photoresist layer is then removed and the wafer is cleaned. Further photolithography steps and fabrication steps may follow.

During the entire manufacturing process, the wafer surface is subdivided into a plurality of cells (dice) which each pass through identical fabrication steps. After the completion thereof, the individual cells are isolated by cutting the wafer, and constitute the basis of so-called chips.

Exposure defects, caused by an incorrect exposure time, exposure dose, or focus, cause so-called macrodefects which usually result in a defective product. The wafer surface is therefore examined for defects, as a rule, after development of the photoresist layer. The reason is that at this point in time, an incorrectly exposed layer can be removed and the wafer can be sent through another photolithography process. This “rework” can considerably reduce wastage.

A system for detecting such exposure defects is labeled 21 in FIG. 2. This system 21 substantially comprises a radiation source 22 for illuminating wafer surface 17 and a camera 23 for acquiring an image of that wafer surface 17, the image obtained then being inspected for possible defects. In this exemplifying embodiment, inspection system 21 is integrated into the manufacturing process of a wafer 16, in which context wafer 16 can be transferred into inspection system 21 after each development step in the photolithography process. For that purpose, wafer 16 is automatically placed onto a support 18 on which it is retained in position preferably by means of vacuum suction. During inspection, wafer 16 is usefully located in a sealed space 20 that meets clean-room criteria.

Radiation source 22 depicted in FIG. 2 encompasses, in an advantageous embodiment, a light guide 12 for delivering radiation energy as well as a lens system 11 for producing telecentric illumination. Light guide 12 and lens system 11 are coupled via a connector piece 13. The actual radiator is, as depicted in FIG. 1A, a small-area planar radiator that is used to produce telecentric illumination by means of lens system 11. The telecentric beam bundles are labeled 14. Radiation source 22 is arranged displaceably on a radial slide 15 so that a suitable illumination angle with respect to the plane of wafer surface 17 can be established, allowing the necessary image contrast to be optimally set.

Camera system 23 encompasses substantially a camera 7, the term “camera” meaning any suitable optical detector or any suitable image sensing device. Camera 7 is, in suitable fashion, a linear or matrix-type image sensor (e.g. CCD or CMOS), in which context monochrome or color cameras can be used. Camera 7 usefully comprises an (at least object space) telecentric objective. The image data of camera 7 are read out pixel-by-pixel via a data line 8, so that the image information obtained can be represented by means of a grayscale image. When polychromatic illumination is used, a grayscale image of this kind is obtained for each color detected.

The use of a telecentric objective has the advantage that each object point on wafer surface 17 is detected from the same spatial direction and at the same solid angle, so that both the illumination characteristics and the observation characteristics are homogeneous over the entire region to be inspected of wafer surface 17. Ideal conditions are thereby created for allowing reliable detection of defects in the examined region.

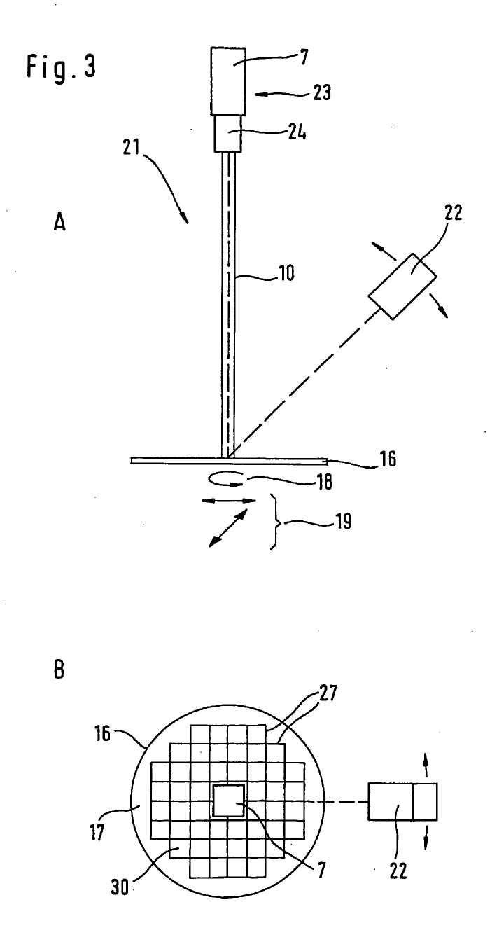

Alternatively, it is also possible to use as the camera objective a non-telecentric objective 9 whose working distance is much greater than the diagonal of the object region. As shown in FIG. 2, an objective 9 of this kind is also advisable because only small solid angles are imaged, as illustrated by image beam path 10. When a telecentric objective 24 is used (see FIG. 3), a parallel image beam path results.

Known image processing and pattern recognition methods, for example comparison of the acquired image with an ideal (or “golden”) image, can be employed for evaluation of the image that is obtained. Specific regions of wafer surface 17 can be inspected successively with the system presented here, but it is also possible to inspect the entire wafer surface globally.

Inspection system 21 depicted here utilizes the advantages of the telecentric illumination according to the present invention to image the object to be inspected, resulting in contrast differences (between defect-free segments on wafer surface 17 and those having, in particular, macrodefects) that are optimum for defect detection. The method and system according to the present invention are especially suitable for the detection of exposure defects in the context of wafer manufacturing.

FIG. 3A shows, in a highly schematic side view, substantially the wafer inspection system 21 according to the present invention already depicted in FIG. 2, camera 7 used here having an (at least object space) telecentric objective 24. The corresponding parallel image beam path is labeled 10. The telecentric radiation source is once again labeled 22. Wafer 16 rests on a rotatable support 18 (indicated by the circular arrow) that can be displaced in the X and Y directions by means of an X-Y scanning stage 19 (see FIG. 2).

All the other components of the wafer inspection system shown in FIG. 3 correspond to those of the system shown in FIG. 2, and will therefore not be discussed further below.

FIG. 3B is a plan view of system 21 shown in FIG. 3A, this depiction also being applicable to a plan view of the system depicted in FIG. 2. Wafer 16, and main structures 27 extending on wafer surface 17, are depicted. The individual cells (dice) formed by these main structures 27 are labeled 30. These cells 30 are processed into chips later in the processing procedure. As is evident from FIG. 3B, the projection of the axis of beam bundles 14 of telecentric radiation source 22 onto wafer surface 17 extends substantially parallel to one of the main structures 27 on wafer surface 17 (in this case, to the main structures depicted horizontally). in this embodiment, camera 7 is located perpendicularly above wafer surface 17 and directed onto the region to be inspected. It has been found that with this arrangement of the illumination and observation directions, macrodefects in the region to be inspected can be imaged with high contrast.

It is useful if, as shown in FIG. 3B, telecentric radiation source 22 is both displaceable in terms of its radiation direction (in a plane parallel to wafer surface 17) with respect to main structures 27 on wafer surface 17, and displaceable for adjustment of the illumination angle with respect to wafer surface 17 (see FIG. 3A and FIG. 2).

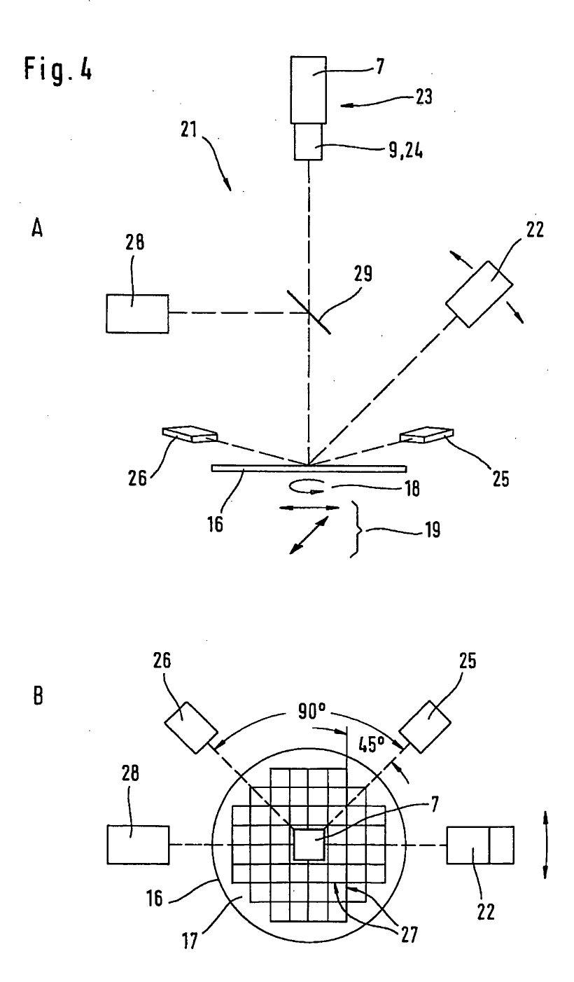

FIG. 4 once again shows a wafer inspection system 21 according to FIG. 3 in highly schematic form, so that reference can be made to the entire content of the previously explained system depicted in FIG. 3. In a first embodiment, the system according to FIG. 4 exhibits an additional bright-field irradiation source 28. In a second embodiment, this system exhibits two additional dark-field irradiation sources 25 and 26. For simplicity's sake, both embodiments are depicted in combination in FIG. 4. It should be noted, however, that each of the two embodiments can be implemented in the same fashion individually, without the respective other embodiment, in the wafer inspection system.

The radiation of bright-field irradiation source 28 is directed via a semitransparent beam splitter 29 perpendicularly onto the region to be inspected of wafer surface 17. This additional observation in bright-field mode can be useful, in some circumstances, for detecting defects such as color or wetting defects, if the latter cannot be detected using only the telecentric illumination according to the present invention.

As depicted in the plan view of FIG. 4B, the two dark-field irradiation sources 25 and 26 are arranged at a 90-degree angle to one another in terms of their illumination direction. As a result, each of the two dark-field irradiation sources 25 and 26 can illuminate, at a 45-degree angle, main structures 27 extending on wafer surface 17. With respect to wafer surface 17, the dark-field illumination is accomplished at an oblique or raking incidence (see FIG. 4A). It has been found that under the conditions selected here, observation in dark-field mode can depict defects such as scratches or particles on the wafer surface with high contrast.

### Parts List

1 Radiator, optical waveguide

2 Lens system

3 Beam bundle

4 Illumination aperture

5 Object plane

6 Axes of beam bundles

7 Camera

8 Data line

9 Objective of camera

10 Image beam path

11 Lens system

12 Light guide

13 Connector piece

14 Beam bundle

15 Radial slide

16 Wafer

17 Wafer surface

18 Support

19 X-Y scanning stage

20 Space

21 Inspection system

22 Radiation source

23 Camera system

24 Telecentric objective of camera

25 Dark-field irradiation source

26 Dark-field irradiation source

27 Main structure on wafer surface

28 Bright-field irradiation source

29 Beam splitter

30 Cell (die)

1. A method for inspecting a wafer, comprising:
telecentrically illuminating, with a radiation source, at least one region of the wafer surface to be inspected;
acquiring an image of the at least one region using a camera; and
inspecting the at least one region using the acquired image.

2. The method as recited in claim 1 wherein the inspecting is performed so as to detect macrodefects.

3. The method as recited in claim 2 wherein the macrodefects include exposure defects.

4. The method as recited in claim 1 wherein the radiation source includes a substantially point-like radiator and a lens system disposed downstream therefrom so as to illuminate the at least one region to be inspected with a small illumination aperture.

5. The method as recited in claim 1 further comprising optimizing an image contrast by adjustments of an illumination angle relative to a plane of the wafer surface.

6. The method as recited in claim 1 further comprising optimizing an image contrast by adjustments of an illumination angle relative to an extension of structures of the wafer.

7. The method as recited in claim 1 wherein the camera includes an objective, a working distance being substantially greater than a diagonal of an object field thereof.

8. The method as recited in claim 1 wherein the camera includes a telecentric objective.

9. The method as recited in claim 1 wherein the illuminating is performed polychromatically.

10. The method as recited in claim 1 wherein the illuminating is performed monochromatically.

11. The method as recited in claim 1 wherein the illuminating is performed with wavelengths in a visible through an ultraviolet region.

12. The method as recited in claim 1 wherein the illuminating is performed in an incident mode.

13. The method as recited in claim 12 wherein the illuminating is performed at an angle in a range from 3° to 90° relative to the wafer surface.

14. The method as recited in claim 1 further comprising illuminating the at least one region in an incident dark-field mode using a second radiation source.

15. The method as recited in claim 14 wherein the second radiation source includes a third and a fourth dark-field irradiation source disposed so that respective radiation directions thereof enclose an angle of approximately 90°.

16. The method as recited in claim 14 wherein the second radiation source includes at least one dark-field irradiation source disposed so that a projection of a radiation direction thereof onto the wafer surface encloses an angle of approximately 45° relative to a main structure extending on that wafer surface.

17. The method as recited in claim 1 further comprising illuminating the at least one region in an incident bright-field mode.

18. The method as recited in claim 1 wherein the illuminating is performed so that a projection of a telecentric beam bundle onto the wafer surface extends substantially parallel to a main structure extending on the wafer surface.

19. The method as recited in claim 1 wherein the camera is disposed so that a main axis thereof is substantially parallel to a surface normal line of the wafer surface and is directed onto the at least one region of the wafer surface.

20. The method as recited in claim 1 wherein the radiation source includes a small-area planar radiator and a lens system disposed downstream therefrom so as to illuminate the at least one region to be inspected with a small illumination aperture.

21. A wafer inspection system for inspecting a wafer, comprising:
a radiation source configured to illuminate, using telecentric illumination, at least one region of the wafer surface to be inspected; and
a camera configured to acquire an image of the at least one region.

22. The system as recited in claim 21 wherein the inspecting includes detecting macrodefects.

23. The system as recited in claim 22 wherein the macrodefects include exposure defects.

24. The system as recited in claim 21 wherein the radiation source includes a substantially point-like radiator and a lens system disposed downstream thereof so as to provide radiation with a small illumination aperture.

25. The system as recited in claim 21 wherein the radiation source includes a small-area planar radiator and a lens system disposed downstream thereof so as to provide radiation with a small illumination aperture.

26. The system as recited in claim 25 wherein the small-area planar radiator includes an optical waveguide.

27. The system as recited in claim 21 wherein the camera includes an objective, a working distance being substantially greater than a diagonal of an object field thereof.

28. The system as recited in claim 21 wherein the camera includes a telecentric objective.

29. The system as recited in claim 21 wherein the camera is disposed so that an axis thereof is substantially parallel to a surface normal line of the wafer surface and is directed onto the at least one region of the wafer surface.

30. The system as recited in claim 21 further comprising a second radiation source including at least one dark-field irradiation source configured to illuminate the at least one region to be inspected.

31. The system as recited in claim 30 wherein the at least one dark-field irradiation source includes a first and a second dark-field irradiation source disposed so that respective radiation directions enclose an angle of approximately 90°.

32. The system as recited in claim 21 further comprising a bright-field irradiation source configured to illuminate the at least one region to be inspected.
